(19) United States
(12) Patent Application Publication
(10) Pub. No.: US 2018/0158078 A1
(43) Pub. Date: Jun. 7, 2018

(54) COMPUTER DEVICE AND METHOD FOR PREDICTING MARKET DEMAND OF COMMODITIES

(71) Applicant: Institute For Information Industry, Taipei (TW)

(72) Inventors: Pei-Yu HSIEH, New Taipei City (TW); Hong-Han SHUAI, New Taipei City (TW); De-Nian YANG, Taipei City (TW); Yi-Chun CHEN, Taoyuan City (TW); Meng-Jung SHIH, Taoyuan City (TW); Chieh-Yu LIAO, New Taipei City (TW); Chen-Yu WANG, New Taipei City (TW)

(21) Appl. No.: 15/372,374

(22) Filed: Dec. 7, 2016

(30) Foreign Application Priority Data
Dec. 5, 2016 (TW) 105140087

(51) Int. Cl. G06Q 30/02; G06N 99/00

(52) U.S. Cl. CPC G06Q 30/0202; G06N 99/005

(57) ABSTRACT

Embodiments disclosed relate to a computer device and a method for predicting market demand of commodities. The method includes: creating multiple-sources data for each of a plurality of commodities, wherein each of the all multiple-sources data comes from a plurality data sources; storing the all multiple-sources data; extracting a plurality of features from a corresponding one of the all multiple-sources data for each of the commodities to build a feature matrix for each of the data sources; performing a tensor decomposition process on the feature matrices to produce at least one latent feature matrix; and performing a deep learning process on the at least one latent feature matrix to build a prediction model and predicting market demand of each of the commodities according to the prediction model.

### PRIORITY

This application claims priority to Taiwan Patent Application No. 105140087 filed on Dec. 5, 2016, which is hereby incorporated by reference in its entirety.

### FIELD

Embodiments disclosed relate to a computer device and a method thereof, and more particularly, relate to a computer device and a method for predicting market demand of commodities.

### BACKGROUND

It is always the case that those who can accurately predict market demand of commodities will get a market share of the commodities no matter in the conventional commerce businesses or in the newly emerging E-commerce businesses. This is mainly because the market demand is closely related to the cost and revenues of the commodities. For example, accurately predicting the market demand of commodities can not only reduce or avoid the inventory of commodities (i.e., reduce the cost of commodities) but also increase the sales volume of commodities (i.e., increase the revenue of commodities).

Building a prediction model for market demand through statistical analysis on known commodity data is a technical concept that has already been known. In the early days when the numbers of commodity categories, commodity sales channels and commodity data sources are all limited, the number of factors that affect the market demand is relatively small, so the prediction model built for market demand is usually a simple model built through statistical analysis on single data of a single commodity. For example, a prediction model is built through statistical analysis on the known sales volume of a certain kind of commodity in a certain physical store, and is then used to predict a further sales volume of this kind of commodity.

Nowadays, as the numbers of the commodity categories, commodity sales channels and commodity data sources increase, the number of factors that affect the market demand increases and, moreover, these factors also have influences on each other. Therefore, the conventional simple prediction model has become unable to effectively predict the market demand of the modern commodities. As an example, the conventional simple prediction model is unable to take possible influence of the known sales volume of a certain commodity on a further sales volume of another commodity into consideration. As another example, the conventional simple prediction model cannot take the following factor into consideration: the further sales volume of a certain commodity predicted according to the known sales volume of this commodity in a certain physical store may vary remarkably due to evaluations of this commodity in the community network.

Accordingly, providing an effective solution for predicting market demand of commodities under conditions of the increased numbers of commodity categories, commodity sales channels and commodity data sources becomes an important objective in the art.

### SUMMARY

The disclosure includes a computer device and a method for predicting market demand of commodities.

The computer device for predicting market demand of commodities may include a processor and a storage. The processor may be configured to create multiple-sources data for each of a plurality of commodities, wherein each of the all multiple-sources data comes from a plurality of data sources. The storage may be configured to store the all multiple-sources data. The processor may be further configured to extract a plurality of features from a corresponding one of the all multiple-sources data for each of the commodities to build a feature matrix for each of the data sources. The processor may be further configured to perform a tensor decomposition process on the feature matrices to produce at least one latent feature matrix. The processor may be further configured to perform a deep learning process on the at least one latent feature matrix to build a prediction model and predict market demand of each of the commodities according to the prediction model.

The method for predicting market demand of commodities may comprise:

creating multiple-sources data by a computer device for each of a plurality of commodities, wherein each of the all multiple-sources data comes from a plurality of data sources;

storing the all multiple-sources data by the computer device;

extracting a plurality of features from a corresponding one of the all multiple-sources data by the computer device for each of the commodities to build a feature matrix for each of the data sources;

performing a tensor decomposition process by the computer device on the feature matrices to produce at least one latent feature matrix; and

performing a deep learning process by the computer device on the at least one latent feature matrix to build a prediction model and predicting market demand of each of the commodities according to the prediction model.

According to the above descriptions, in order to take more factors that may affect the market demand into consideration, the present invention builds a prediction model for predicting market demand according to multiple-sources data of commodities. Therefore, as compared with the conventional simple prediction model, the prediction model built according to the present invention can provide more accurate prediction of market demand of the modern commodities. Further in the process of building the prediction model, a tensor decomposition process is adopted to decompose the original feature matrix, so additional computations caused by taking more factors that may affect the market demand into consideration can be reduced and additional noises/interference data caused by taking more factors that may affect the market demand into consideration can be rejected. Thereby, an effective solution for predicting market demand of commodities is provided in the present invention under conditions of the increased numbers of commodity categories, commodity sales channels and commodity data sources.

What described above presents a summary of the present invention (including the problem to be solved, the means to solve the problem and the effect of the present invention) to provide a basic understanding of the present invention. However, this is not intended to encompass all aspects of the present invention. Additionally, what described above is neither intended to identify key or essential elements of any or all aspects of the present invention, nor intended to define the scope of any or all aspects of the present invention. This summary is provided only to present some concepts of some aspects of the present invention in a simple form and as an introduction to the following detailed description.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a computer device for predicting market demand of commodities according to one or more embodiments of the present invention;

FIG. 2 illustrates a correspondence relationship between individual commodities and a plurality of data sources according to one or more embodiments of the present invention;

FIG. 3 illustrates a process of building a feature matrix according to one or more embodiments of the present invention;

FIG. 4A illustrates a process of performing a tensor decomposition process according to one or more embodiments of the present invention;

FIG. 4B illustrates a process of performing another tensor decomposition process according to one or more embodiments of the present invention; and

FIG. 5 illustrates a method for predicting market demand of commodities according to one or more embodiments of the present invention.

### DETAILED DESCRIPTION

The example embodiments described hereinafter are not intended to limit the present invention to any specific example, embodiment, environment, applications, structures, processes or steps described in these example embodiments.

In the attached drawings, elements unrelated to the present invention are omitted from depiction. In the attached drawings, dimensions of individual elements and dimensional scales among the individual elements are illustrated only as examples, but not to limit the present invention. Unless otherwise stated, like (or similar) reference numerals can correspond to like (or similar) elements in the following descriptions.

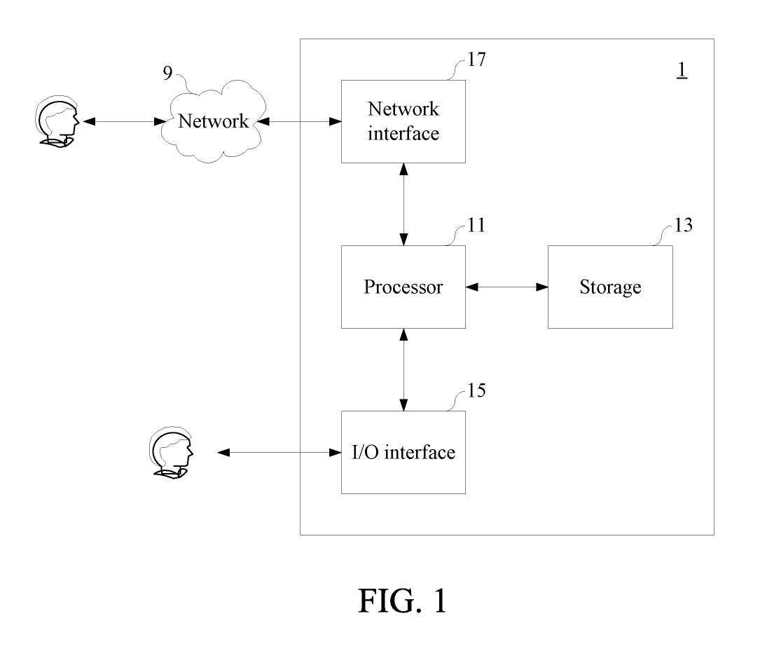

FIG. 1 illustrates a computer device for predicting market demand of commodities according to one or more embodiments of the present invention. However, the computer device illustrated in FIG. 1 is provided only as an exemplary example, but not to limit the present invention. Referring to FIG. 1, a computer device 1 may comprise a processor 11 and a storage 13. The computer device 1 may further comprise other elements, for example but not limited to, an I/O interface 15 and a network interface 17. The processor 11, the storage 13, the I/O interface 15 and the network interface 17 may be electrically connected either via some media or elements such as various buses (i.e., in the form of indirect electrical connection) or without the need of any medium or element (i.e., in the form of direct electrical connection). With this direct electrical connection or indirect electrical connection, signal transmission and data exchange can be accomplished between the processor 11, the storage 13, the I/O interface 15 and the network interface 17. The computer device 1 may be any kind of computer devices, for example but not limited to, a smartphone, a notebook computer, a tablet computer, a desktop computer or the like.

The processor 11 may be a central processing unit (CPU) used in a general-purpose computer device/computer, and may be programmed to interpret computer instructions, process data in computer software and execute various computing programs. The CPU may be a processor formed by a plurality of independent units or a microprocessor comprised of one or more integrated circuits (ICs).

The storage 13 may comprise various storage units used in a general-purpose computer device/computer. The storage 13 may comprise a first-level memory (a.k.a. a primary memory or an internal memory), usually simply called a memory, which directly communicates with the CPU. The CPU can read instruction sets stored in the memory and execute theses instruction sets if necessary. The storage 13 may further comprise a second-level memory (a.k.a. an auxiliary memory or an external memory), which communicates with the CPU not directly but through an I/O channel of the memory and transmits data to the first-level memory via a data buffer. Data stored in the second-level memory will not be lost when the power is turned off (i.e., being non-volatile). The second-level memory may be, e.g., any of various kinds of hard disks, compact disks (CDs) and so on. The storage 13 may also comprise a third-level storage device, i.e., a storage device that can be directly plugged into or removed from the computer (e.g., a mobile disk).

The I/O interface 15 may comprise various input/output elements used in a general-purpose computer device/computer for receiving data from and transmitting data to the outside, for example but not limited to, a mouse, a trackball, a touch panel, a keyboard, a scanner, a microphone, a user interface (UI), a screen, a touch screen, a projector and so on. The network interface 17 may comprise at least one physical network interface card used in a general-purpose computer device/a computer for use as an interconnection point between the computer device 1 and a network 9. The network 9 may be a private network (e.g., a local area network (LAN)) or a public network (e.g., the Internet). The network interface 17 may allow the computer device 1 to communicate with and exchange data with other electronic devices on the network 9 either in a wired or wireless access way depending on different needs. In some embodiments, there may also be a switching device, a routing device or the like between the network interface 17 and the network 9.

The computer device illustrated in FIG. 1 may be used to predict various kinds of market demand of commodities, for example but not limited to, commodity sales volume, commodity popularity, commodity price and so on. Hereinafter, predicting the sales volume of commodities will be taken as an example of predicting the market demand of commodities for description, but this is not intended to limit the present invention.

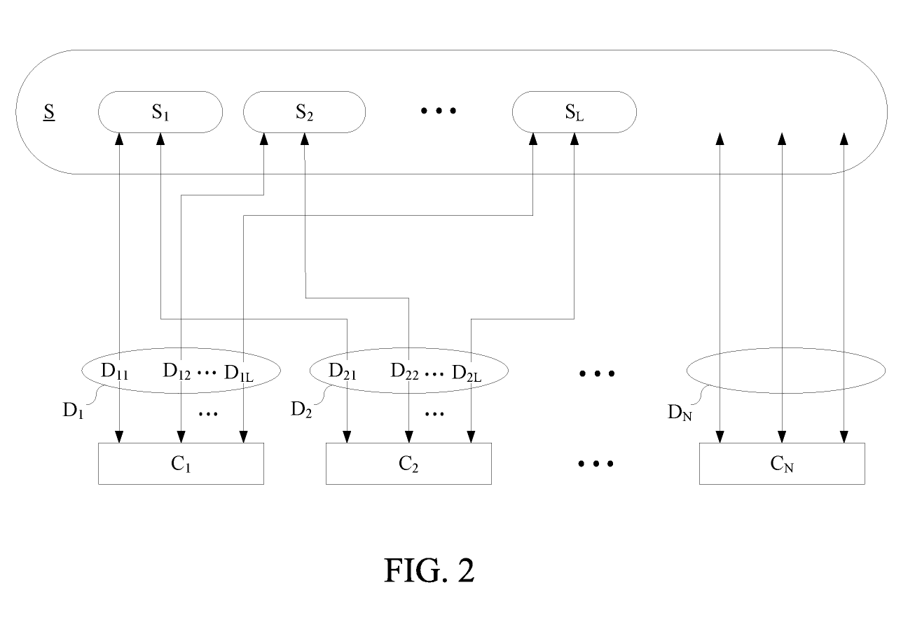

FIG. 2 illustrates a correspondence relationship between individual commodities and a plurality of data sources according to one or more embodiments of the present invention. However, the correspondence relationship illustrated in FIG. 2 is provided only as an exemplary example, but not to limit the present invention. Referring to FIG. 1 and FIG. 2 and assuming that a data source space S comprises a plurality of data sources S₁˜S_{L}, the processor 11 may be configured to create multiple-sources data D₁˜D_{N} respectively for each of a plurality of commodities C₁˜C_{N}, and the storage 13 may be configured to store the all multiple-sources data D₁˜D_{N}, where each of the all multiple-sources data D₁˜D_{N} may come from a plurality of data sources S₁˜S_{L}. N is the total number of commodities, L is the total number of data sources, and N and L may be integers greater than or equal to 1.

In some embodiments, the commodities C₁˜C_{N} may be of a same category, and the scope of the same category may be determined depending on different needs. For example, the commodities C₁˜C_{N} may be any commodity of the 3C commodity category, or any commodity of the communication commodity sub-category of the 3C commodity category.

In some embodiments, the storage 13 may store in advance all data that can be provided by the data sources S₁˜S_{L}. In some embodiments, the processor may obtain all the data that can be provided by the data sources S₁˜S_{L} directly from the outside via the I/O interface 15 or the network interface 17.

In some embodiments, the data sources S₁˜S_{L} may be various sources that can provide commodity data related to the commodities C₁˜C_{N}, for example but not limited to, physical sales platforms, network sales platforms, community networks and so on.

In some embodiments, the processor 11 may create a knowledge tree for the commodities C₁˜C_{N} in the storage in advance to define the conceptual hierarchy of the commodities, for example, define a first level of commodity categories, a second level of commodity brands and a third level of commodity. Additionally, the processor 11 may store information related to respective names of the commodities C₁˜C_{N} and synonyms in the storage 13 in advance by means of various network information providers (e.g., Wikipedia). Then the processor 11 may perform a synonym integration process and a text match-making process on each of the commodities C₁˜C_{N} in the data sources S₁˜S_{L} to create the multiple-sources data D₁˜D_{N} related to the commodities C₁˜C_{N} respectively.

For example, for each of the commodities C₁˜C_{N}, the processor 11 may select data in which the same commodity name or its synonym appears from all data provided by the data sources S₁˜S_{L} according to the commodity information and synonym information of the knowledge tree and unify the commodity name appearing in the selected data in the synonym integration process. In the text match-making process, the processor 11 may compare a commodity and a commodity brand appearing in each selected data with a corresponding commodity and a corresponding commodity brand in the knowledge tree to determine whether a sum of text similarities therebetween exceeds a prediction threshold value. If the answer is “Yes”, then the processor 11 can determine that this selected data is just the data related to the commodity.

Taking FIG. 2 as an example and assuming that, among all the data provided by the data sources S₁˜S_{L}, data related to the commodity C₁ are D₁₁˜D_{1L} respectively and data related to the commodity C₂ are D₂₁˜D_{2L} respectively, then the processor 11 may determine the data D₁₁˜D_{1L} as the multiple-sources data D₁ of the commodity C₁ and determine the data D₂₁˜D_{2L} as the multiple-sources data D₂ of the commodity C₂. Thus, the multiple-sources data D₁˜D_{N} related to the commodities C₁˜C_{N} can be created by the processor 11 respectively.

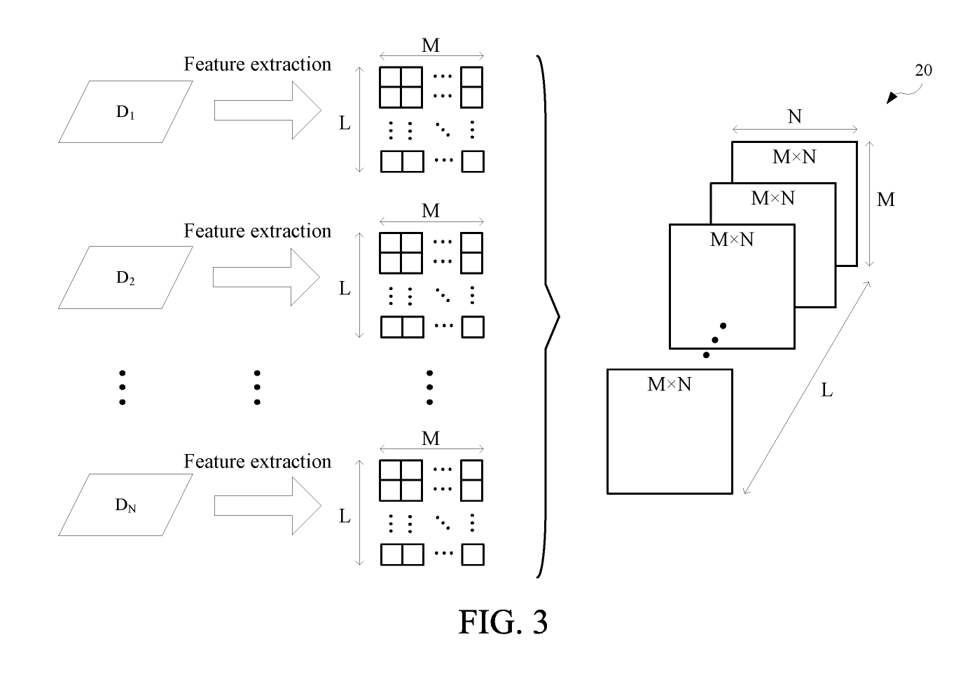

FIG. 3 illustrates a process of building a feature matrix according to one or more embodiments of the present invention. However, the process illustrated in FIG. 3 is only provided as an exemplary example, but not to limit the present invention. Referring to FIG. 3, after the multiple-sources data D₁˜D_{N} have been created, the processor 11 may extract a plurality of features (which may be represented as an L×M matrix) from a corresponding multiple-sources data among the multiple-sources data D₁˜D_{N} for each of the commodities C₁˜C_{N} so as to build a feature matrix 20 (which may be represented as a M×N matrix) for each of the data sources S₁˜S_{L}. N is the total number of commodities, L is the total number of data sources, M is the total number of features, and N, L, and M may be integers greater than or equal to 1.

In some embodiments, the L features extracted by the processor 11 for each of the commodities C₁˜C_{N} respectively may include at least one commodity feature, and the at least one commodity feature is associated with at least one of commodity basic data, an affecting commodity factor, a commodity evaluation and a commodity sales record. The commodity data may include but is not limited to: price, capacity, weight, series, date of listing, attribute, brand, place of origin and so on. The affecting commodity factor may include but is not limited to: market share of the brand, appealing effect, commodity performance, appealing target customers, commodity saturation, commodity material, commodity shape and so on. The commodity evaluation may include but is not limited to: user experience, cost performance, commodity score, commodity evaluation score, commodity popularity index and so on. The commodity sales record may include but is not limited to: commodities that are often browsed together, commodities that are often bought together, the number of browsing times, the number of times that shopping carts are cancelled, variation in sales volume, accumulated sales volume, growth rate of sales volume, rate of the sales volume relative to the last month or to the same period of the last year.

In terms of the sales volume of commodity, more kinds of commodity features may be produced according to different time dimensions (e.g., on the basis of day, week, month, quarter, year, etc.). These features may be divided into two categories: the first category is the time sequence features, and the second category is the fluctuation features. Assuming that nₖ commodities and nₖ₊₁ commodities are sold at the time points k and k+1 respectively, then the time sequence features may include but are not limited to: average single-step rising rate of the sales volume, average two-step rising rate of the sales volume, average propagation rate of the last L time windows of the sales volume, and average single-step rising rate of the last L time windows of the sales volume.

The average single-step rising rate of the sales volume may be represented as follows:

$$\frac{1}{K - 1} {\sum }_{k = 1}^{K - 1} \frac{{n}_{k + 1} - {n}_{k}}{{n}_{k}} \qquad ( 1 )$$

The average two-step rising rate of the sales volume may be represented as follows:

$$\frac{1}{K - 2} {\sum }_{k = 1}^{K - 2} \frac{{n}_{k + 2} - {n}_{k}}{{n}_{k}} \qquad ( 2 )$$

Given that t represents a time window length, the average propagation rate of the last L time windows of the sales volume may be represented as follows:

$$\frac{1}{L} {\sum }_{i = 1}^{L} \frac{{n}_{K - i}}{t} \qquad ( 3 )$$

The average single-step rising rate of the last L time windows of the sales volume may be represented as follows:

$$\frac{1}{L - 1} {\sum }_{i = 0}^{L - 1} \frac{{n}_{K - i} - {n}_{K - i - 1}}{{n}_{K - i - 1}} \qquad ( 4 )$$

The fluctuation features may include but are not limited to: time, the number of local spikes and average regular distance between two spikes. Assuming that M is the number of spikes and d(i,j) is a distance between the i^{th} spike and the j^{th} spike, then the average regular distance between two spikes may be represented as follows:

$$\frac{1}{M} {\sum }_{i = 1}^{M - 1} d ( i , i + 1 ) \qquad ( 5 )$$

In some embodiments, the L features extracted by the processor 11 for each of the commodities C₁˜C_{N} respectively may include at least one text feature, and the processor 11 may extract the at least one text feature according to at least one of feature factor analysis, emotion analysis and semantic analysis.

The feature factor analysis may help the processor 11 to find important text features related to commodities from text information such as news and community comments. The word is a smallest language unit that is meaningful and that can be used freely, and any language processing systems must be able to resolve words in texts in order to perform further processing. Therefore, the processor 11 may first slice the text information in units of words by use of various open-source segmentation tools or by means of N-gram. N-gram is a method commonly used in natural language processing and may be used to calculate the co-occurrence relation between characters, so it is helpful for segmentation or for calculation of productivity of vocabularies.

The processor 11 may detect feature factors through various kinds of text feature recognizing methods after obtaining the segmentation result. For example, if there is no category structure of the commodity to be determined, the processor 11 may adopt Term Frequency-Inverse Document Frequency (TF-IDF) to calculate importance of terms, where TF-IDF may be represented as follows:

$${tf}_{i} = log ( {\sum }_{k}^{ } {n}_{k , i} ) \\ {idf}_{i} = log \frac{\vert D \vert}{\{ j : {t}_{i} ∈ {d}_{j} \}} \\ {tfidf}_{i} = {tf}_{i} \times {idf}_{i} \qquad ( 6 )$$

where tfᵢ is the total number of times that the term i appears in a document set k; idfᵢ is an inverse document frequency of the term i; D is the total number of documents; and dⱼ is the number of documents where the term i appears.

TF-IDF is a weighting technology commonly used for information retrieval and text mining TF-IDF is essentially a kind of statistical method, which may be used to evaluate the importance of a term for a document set or for one document in a corpus. The importance of a term increases in direct proportion to the number of times that it appears in documents, but decreases in inverse proportion to the frequency at which it appears in the corpus. Descriptions related to TF-IDF in Wikipedia (website: https://en.wikipedia.org/wiki/Tf%E2%80%93idf) are incorporated herein by reference in its entirety.

As another example, if there are category structures of the commodity to be determined, the processor 11 may select important terms (i.e., factors) of each category structure through a chi-square test of the four-fold table data. The chi-square test of the four-fold table data may be used for comparison between two rates or two constituent ratios. Assuming that frequencies of four folds of the four-fold table data are A, B, C, D respectively, then the chi-square value of the chi-square test of the four-fold table data may be represented as follows:

$${x}^{2} ( t , {c}_{j} ) = \frac{N \times {( AD - CB )}^{2}}{( A + C ) \times ( B + D ) \times ( A + B ) \times ( C + D )} \qquad ( 7 )$$

where N is the total number of documents; t is the term; cⱼ is the category; A is the number of times that the term t appears in a certain category; B is the number of time that the term t appears in other categories than the certain category; C is the number of times that other terms than the term t appear in the certain category; and D is the number of times that other terms than the term t appear in the other categories than the certain category.

Through TF-IDF and the chi-square test, terms related to the commodity and appearing frequently can be found by the processor 11 from text information such as news and community comments; and because terms frequently appearing in text information usually means that the commodity is of a great concern in discussion on the market, the processor 11 may determine the terms appearing frequently as feature factors of the commodity.

In some embodiments, the processor may further convert the feature factors into important text features related to the commodity. For example, the processor 11 may present feature factors distributed in all articles (i.e., j articles) in the form of a vector vⱼ(d_{1,j}, d_{2,j}, . . . , d_{n,j}), and then based on cosine similarity, calculate similarities of any two feature factors in a lot of document sets. The cosine similarity refers to a cosine angle between two non-zero vectors in an inner product space. Descriptions related to cosine similarity in Wikipedia (website: https://en.wikipedia.org/wiki/Cosine_similarity) are incorporated herein by reference in its entirety. Given that vⱼ represents the j^{th} feature factor vector and vₖ represents the k^{th} feature factor vector, the similarity of any two feature factors in a lot of document sets may be represented as follows:

$$cos ( θ ) = \frac{{v}_{j} \cdot {v}_{k}}{‖ {v}_{j} ‖ ‖ {v}_{k} ‖} = \frac{{\sum }_{i = 1}^{n} {d}_{i , j} \cdot {d}_{i , k}}{\sqrt{{\sum }_{i = 1}^{n} {d}_{i , j}^{2}} \cdot \sqrt{{\sum }_{i = 1}^{n} {d}_{i , k}^{2}}} \qquad ( 8 )$$

where θ is the included angle (a smaller value represents a greater similarity between the two feature factors); d_{i,j} is the number of times that the feature factor j appears in the dᵢ^{th} article; and d_{i,k} is the number of times that the feature factor k appears in the dᵢ^{th} article.

After having calculated the similarities of any two feature factors in a lot of document sets according to Formula (8), the processor 11 may determine whether any two feature factors are associated words according to a preset threshold value θₜ, and determines feature factors that are associated words as feature words (feature factors). The processor 11 may further calculate the following features according to the feature words determined: cumulant ACCₜⱼ, the total quantity Qₜⱼ within a time period p and a growth rate Rₜⱼ. Given that t_{i,j} represents the number of times that the feature word (feature factor) tⱼ appears on the i^{th} day, the cumulant ACCₜⱼ, the total quantity Qₜⱼ and a growth rate Rₜⱼ may be represented as follows:

$${ACC}_{{t}_{j}} = {\sum }_{i = 1}^{n} {t}_{i , j} \\ {Q}_{{t}_{j}} = {\sum }_{i = 1}^{p} {t}_{i , j} \\ {R}_{{t}_{j}} = \frac{{t}_{i , j} - {t}_{i - 1 , j}}{{t}_{i - 1 , j}} \qquad ( 9 )$$

The emotion analysis may help the processor 11 to analyze emotions from sentences in text information such as news and community comments. The emotion analysis is performed mainly in units of sentences. The set <F,O> of factor-opinion-pair can be found by the processor 11 according to the feature factors obtained through the aforesaid feature factor analysis and predefined emotion words. For example, the processor 11 may give emotion scores to sentences comprising feature factors according to predefined polarities of emotion words, where positive emotion words are given an emotion score of +1 and negative emotion words are given an emotion score of −1. Then, the processor 11 may determine weights of emotion scores according to the following formula:

$${w}_{i} = \frac{1}{{dis}_{i , j}} \qquad ( 10 )$$

where dis_{i,j} is a distance between a feature factor and an emotion word.

If an emotion words follows a negative word (e.g., no, has not, will not and etc.), then the polarity of the emotion score is reversed (i.e., from a positive value into a negative value, or vice versa). Additionally, if an adversative (e.g., although, yet, but and etc.) is comprised between sentences, then the emotion score of the sentence following the adversative will be given a weight of (1+wᵢ).

The semantic analysis may help the processor 11 to identify a user who actually uses the commodity and a category of the user (e.g., the age level) from text information such as news and community comments. As an example, the processor 11 may identify a user who actually uses the commodity by determining a position where the user's name appears in a sentence (e.g., an active position or a passive position). As another example, the processor 11 may classify users into different customer groups in advance and identify the customer group to which a user belongs according to the user's name. Assuming that “Mum” has been classified into the customer group of “Elders” by the processor 11 and a name of a user who actually uses the commodity is identified to be “Mum” by the processor 11 from the text information such as news and community comments, then the category of the user (e.g., the age level) can also be known together.

In some embodiments, the L features extracted by the processor 11 for each of the commodities C₁˜C_{N} respectively may include at least one community feature, and the at least one community feature may be extracted by the processor 11 according to a community network discussion degree of each of the commodities C₁˜C_{N}. For example, the processor 11 may detect variation in the amount of discussions about the commodity within a time period p, and if the variation is greater than a preset threshold value tₛ, then this is considered as a community event. Then the processor 11 may determine the at least one community feature according to the discussion variation value SEV of the community event. The discussion variation value SEVⱼ of a community event of a commodity j may be represented as follows:

$${SEV}_{j} = \frac{{d}_{n , j} - {d}_{n - p , j}}{{d}_{n - p , j}} \qquad ( 11 )$$

where d_{n,j} is the number of comments involving a product j at a time point n; and d_{n-p,j} is the number of comments involving the product j within the time period p.

In some embodiments, if the number of users of a single community platform is not sufficient, the processor 11 may view different community platforms as a same community network. Then, the processor 11 may identify community influences of individual users according to interactions of the respective users in the community network (e.g., Like, Response with an article, Reply, Label, or Track). In the community network, the event determined according to the SEV formula may be traced back to comments comprised in the event. Additionally, a diffusion range of the influence may be calculated by the processor 11 according to the poster of the comment, users who respond with an article, and users who merely respond to the comment.

After a feature matrix 20 (which may be represented in the form of a M×N matrix) has been built for each of the data sources S₁˜S_{L}, the processor 11 may perform a tensor decomposition process on the feature matrices 20 to produce at least one latent feature matrix 40. Then the processor 11 may perform a deep learning process on the at least one latent feature matrix 40 to build a prediction model and predict market demand of each of the commodities C₁˜C_{N} according to the prediction model.

An excessive number of features will not only degrade computation performances of the prediction model, but also tend to introduce noises into the prediction model. Therefore, in some embodiments, the tensor decomposition process may be performed on the feature matrices 20 first by the processor 11 before performing the deep learning process so as to produce at least one latent feature matrix 40. The tensor decomposition process is a process comprising high-order singular value decomposition, which can effectively compress the input matrix and integrate latent implications expressed by a plurality of features in the input matrix into a latent feature. Because features of similar commodities may be potentially complementary to each other, the problem of data missing can be reduced through the tensor decomposition. Furthermore, in addition to more effectively solving the problem of cold starting by use of data, the tensor decomposition also solves the problem that the data amount would otherwise be too great to be processed. As to the tensor decomposition, the article “Deep Learning in Neural Networks: An Overview” published by J. Schmidhuber in the journal “Neural Networks” is incorporated herein by reference in its entirety.

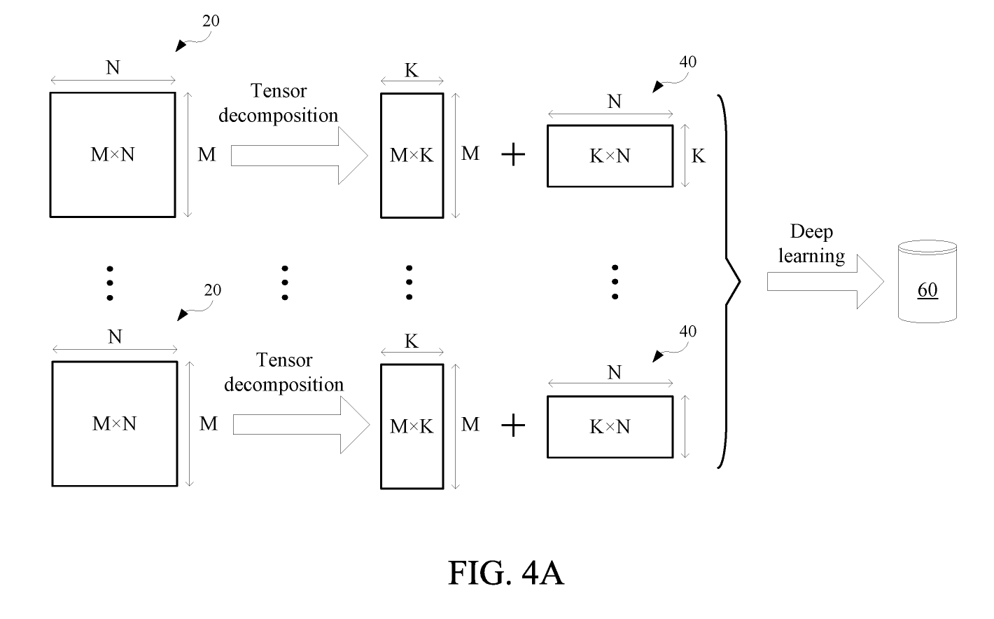

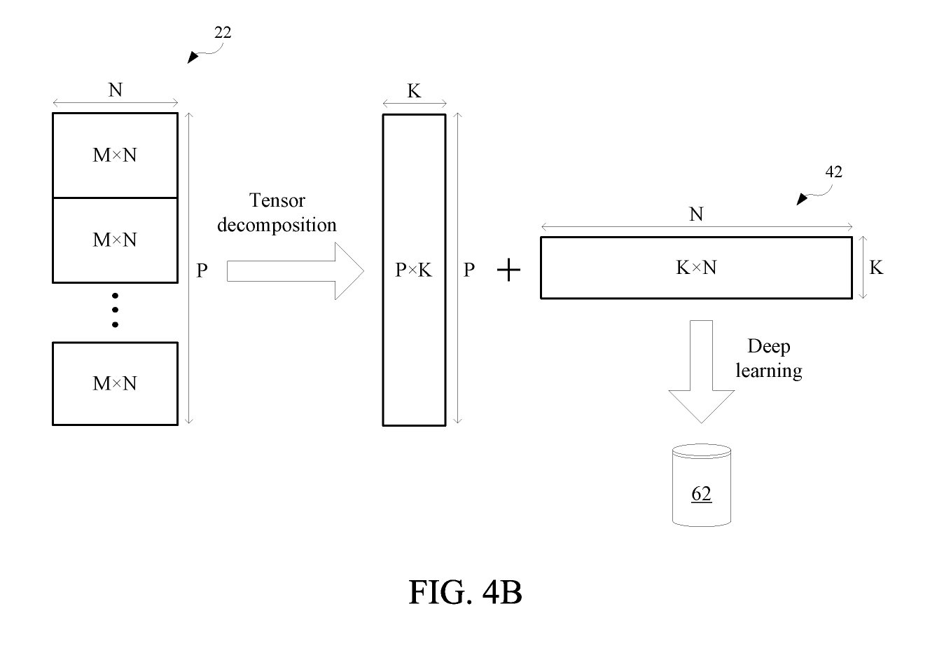

FIG. 4A illustrates a process of performing a tensor decomposition process according to one or more embodiments of the present invention. However, the process illustrated in FIG. 4A is provided only as an exemplary example, but not to limit the present invention. Referring to FIG. 4A, in some embodiments, the processor 11 may perform a tensor decomposition process on each of the L feature matrices 20 respectively according to a predefined feature dimension value K to produce L latent feature matrices 40. In detail, through the tensor decomposition process performed by the processor 11 on each of the M×N feature matrices 20, each of the M×N feature matrices 20 may be decomposed into one M×K matrix and one K×N matrix, where K is just the predefined feature dimension value and is an integer greater than or equal to 1 but smaller than or equal to M. Afterwards, the processor 11 may select the L K×N matrices as the latent feature matrices 40 and performs a deep learning process on the L K×N latent feature matrices 40 to build a prediction model 60. The value of K may be determined by the processor 11 according to the prediction result of the prediction model 60.

FIG. 4B illustrates a process of performing another tensor decomposition process according to one or more embodiments of the present invention. However, the process illustrated in FIG. 4B is provided only as an exemplary example, but not to limit the present invention. Referring to FIG. 4B, in some embodiments, the processor 11 may integrate the L M×N latent feature matrices 20 into one P×N feature matrix 22 first, where P is a product of the total number M of features with the total number L of data sources. Next, the processor may perform a tensor decomposition process on the feature matrix 22 according to a predefined feature dimension value K to produce a latent feature matrix 42. In detail, through the tensor decomposition process performed by the processor 11 on the feature matrix 22, the P×N feature matrix 22 may be decomposed into one P×K matrix and one K×N matrix, where K is just the predefined feature dimension value and is an integer greater than or equal to 1 but smaller than or equal to P. Afterwards, the processor 11 may select the K×N matrix as the latent feature matrix 42 and performs a deep learning process on the K×N latent feature matrix 42 to build a prediction model 62. The value of K may be determined by the processor 11 according to the prediction result of the prediction model 62.

In the L M×N feature matrices 20, there may be a problem of feature value missing or misplacement for some of the N commodities, and such a problem may cause inconsistency in comparison criteria between different commodities, thus leading to errors in subsequent prediction of market demand. Therefore, in some embodiment, the processor 11 may perform a commodity similarity comparing process and a miss value interpolation process on the L M×N feature matrices 20 before performing the tensor decomposition process on the L M×N feature matrices 20. For example, the processor 11 may calculate a similarity between any two of the N commodities according to the following formula in the commodity similarity comparing process:

$$sim ( {v}_{j} , {v}_{k} ) = \frac{{v}_{j} \cdot {v}_{k}}{‖ {v}_{j} ‖ ‖ {v}_{k} ‖} = \frac{{\sum }_{i = 1}^{n} {w}_{i} \cdot {x}_{i , j} \cdot {x}_{i , k}}{\sqrt{{\sum }_{i = 1}^{n} {w}_{i} \cdot {x}_{i , j}^{2}} \cdot \sqrt{{\sum }_{i = 1}^{n} {w}_{i} \cdot {x}_{i , k}^{2}}} \qquad ( 12 )$$

where vⱼ is a feature vector of the j^{th} commodity; vₖ is a feature vector of the k^{th} commodity; x_{i,j} is the i^{th} feature of the j^{th} commodity; x_{i,k} is the i^{th} feature of the k^{th} commodity; wᵢ is 0 if x_{i,j} or x_{i,k} is null, or otherwise is 1.

Next in the miss value interpolation process, the processor 11 may estimate an estimated value of the m^{th} feature (i.e., a missed feature or a misplaced feature) of the n^{th} commodity according to the following formula:

$${x}_{m , n}^{′} = \frac{{\sum }_{i = 1}^{k} sim ( {v}_{n} , {v}_{i} ) \cdot {x}_{m , i}}{{\sum }_{i = 1}^{k} sim ( {v}_{n} , {v}_{i} )} \qquad ( 13 )$$

where x′_{m,n} is the estimated value of the m^{th} feature of the n^{th} commodity, and x_{m,i} is the actual value of the m^{th} feature of the i^{th} commodity.

With Formula (12) and Formula (13), the processor 11 can identify k commodities similar to the target commodity corresponding to the missed feature or the misplaced feature, and estimate the missed feature or the misplaced feature of the target commodity through weighted calculation according to features of the k commodities. For a commodity having a larger similarity, features thereof are assigned larger weights.

As described above, the processor 11 may perform a deep learning process on the L K×N latent feature matrices 40 (K is an integer greater than or equal to 1 but smaller than or equal to M) or on a single K×N latent feature matrix 40 (K is an integer greater than or equal to 1 but smaller than or equal to P). In detail, the deep learning is a machine learning method for feature learning based on data, which can automatically extract feature inadequate to represent features of data through linear on non-linear transformation in a plurality of processing layers. The objective of feature learning is to find better representation manners and build a better model so as to learn these representation manners from massive unlabeled data. The deep learning process described above may comprise various known deep learning architectures, for example but not limited to, Deep Neural Network (DNN), Convolutional Neural Network (CNN), Deep Belief Network, Recurrent Neural Network and so on.

For ease of description, DNN will be taken as an example for the following description. However, this is not intended to limit the present invention. The artificial neural network is a kind of mathematic model that simulates the biological neural system. Usually there are multiple levels in the artificial neural network, each of which comprises tens of to hundreds of neurons. The neurons take inputs from neurons of an upper level, sum up the inputs, and perform activation function transformation to generate an output of the neurons. Each neuron has such a special connection relationship with neurons of a lower level that the output value from neurons of the upper level is weighted and then transmitted to neurons of the lower level. DNN is a kind of discrimination model, which can use a reverse propagation algorithm for training and use a gradient descent algorithm for weight calculation.

In some embodiments, the processor 11 may also introduce various autoencoder technologies into the deep learning process to solve the problems of overfitting and excessive computations of DNN. The autoencoder is a technology for reproducing an input signal in the artificial neural network. In detail, in an artificial neural network, an input signal of a first level may be input into an encoder to generate a code, which is then input into a decoder to generate an output signal. A smaller difference between the input signal and the output signal (i.e., the smaller reconstruction error) means that the code can represent the input signal more truly. Then, by using the code to represent an input signal of the second level in the artificial neural network and performing the aforesaid reconstruction error calculation (i.e., encoding motion, decoding motion and determining motion), a code value of the second level may be obtained. This process is repeated until the code of the input signal of each level is obtained.

The processor 11 may set the following target function for the L K×N latent feature matrices 40 shown in FIG. 4A:

min_{Θ{θ}_{ⱼ}_{}} [symbol] =∈(x_{S},\hat{x}_{S})+γΩ(Θ,Θ′)+αl(z_{S},y_{S};{θⱼ}) (14)

where:
∈(x_{S},\hat{x}_{S})=Σⱼ₌₁^{r}Σᵢ₌₁ⁿ^{ⱼ}∥x_{S}_{ᵢ}−\hat{x}_{S}_{ᵢ}∥², x_{S} is a feature set of the L latent feature matrices 40, \hat{x}_{S} is a feature set reconstructed by encoding and decoding x_{S}, r is the total number L of the data sources S₁˜S_{L}, and nⱼ is the total number of features in the feature set;
Ω(Θ,Θ′)=∥W∥²+∥b∥²+∥W′∥²+∥b′∥², Θ={W,b}, Θ′={W′,b′}, W and b are a weight matrix and a deviation vector of the encoder respectively, and W′ and b′ are a weight matrix and a deviation vector of the decoder respectively;
l(z_{S},y_{S};{θⱼ})=Σⱼ₌₁^{r}(−Σᵢ₌₁ⁿ^{ⱼ} log σ(y_{S}_{ᵢ}^{(j)}θⱼ^{T}z_{S}_{ᵢ}^{(j)})+λθⱼ^{T}θⱼ), z_{S} is a code of x_{S}, y_{S} is a labeled feature in the feature set, θⱼ is a parameter vector of the j^{th} classifier, and σ(⋅) is an S function (sigmoid function); and
γ, α, and λ are adjustable parameters ranging from 0˜1.

The target function of Formula (14) is equivalent to that Θ (i.e., the weight matrix and the deviation vector of the encoder), Θ′ (i.e., the weight matrix and the deviation vector of the decoder) and {θⱼ} (i.e., the set of parameter vectors of all source classifiers) are calculated under conditions of minimizing ∈(x_{S},\hat{x}_{S}), Ω(Θ,Θ′) and l(z_{S},y_{S};{θⱼ}). ∈(x_{S},\hat{x}_{S}) is a reconstruction error that results after encoding of the autoencoder, and is intended to minimize an error between the result obtained by processing the feature matrix in the autoencoder (which is similar to feature selection, but is intended to select a feature favorable for prediction) and the original feature matrix. Ω(Θ,Θ′) is a regulation of the parameter Θ, and is used to avoid excessive feature dependence due to excessive values of W and b so as to select features unsuitable for representing the input signal from x_{S}. l(z_{S},y_{S};{θⱼ}) is the sum of losses of classifiers on labeled data of corresponding data sources (i.e., predicted errors of each of the source classifiers), where smaller predicted errors are preferred.

The processor 11 may calculate closed-form solutions of Θ, Θ′ and {θⱼ} shown in Formula (9) according to the Gradient Descent algorithm or the like algorithm. In some embodiments, the processor 11 may build a classifier f_{T} (equivalent to the prediction model 60 or 62) represented by θ_{T} according to the following formula after the closed-form solutions of Θ, Θ′ and {θⱼ} are calculated:

$${f}_{T} ( {x}_{T} ) = \frac{1}{r} {\sum }_{j = 1}^{r} σ ( {θ}_{j}^{T} ( σ ( {Wx}_{T} + b ) ) ) \qquad ( 15 )$$

x_{T} is the feature set of the target commodity (which may be any of the commodities C₁˜C_{N}), and f_{T}(x_{T}) is the market demand (e.g., sales volume of the commodity) predicted by the prediction model 60 or 62 for the target commodity. Formula (15) is equivalent to voting for (e.g., through averaging) the market demand predicted by each of the classifier f_{T} and then taking the voting result as the market demand of the target commodity.

In some embodiments, after the closed-form solutions of Θ, Θ′ and {θⱼ} have been calculated, the processor 11 may encode x_{S} into z_{S} by means of the autoencoder again, and then train the labeled features according to various classifying algorithms (e.g., Support Vector Machine, Logistic Regression and so on) to derive a unified classifier f_{T} (equivalent to the prediction model 60 or 62) represented by θ_{T}. Afterwards, the unified classifier f_{T} is used to estimate the market demand of the target commodity.

For the single K×N latent feature matrix 42 (K is an integer greater than or equal to 1 but smaller than or equal to P) shown in FIG. 4B, the processor 11 derives a classifier f_{T} or a unified classifier f_{T} represented by θ_{T} according to Formula (14) and Formula (15) in the similar way with the only difference lying in that the total number r of data sources is set to be 1 in Formula (14) and Formula (15) in this case.

In some embodiments, the deep learning process may further comprise a transfer learning process so that the processor 11 may predict market demand of a new commodity according to the prediction model 60 or 62. The new commodity described herein may be a commodity corresponding to data having no label feature or a commodity corresponding to new data that is unknown (or data having not been trained).

For example, the processor 11 may adopt a consensus regularized autoencoder to implement the aforesaid transfer learning process. The consensus regularized autoencoder may allow training data and results (data comprising labeled features) in multiple source fields transferred to be used in feature learning in a new field to predict the market demand of the new commodities while still keeping the prediction error of the artificial neural network as little as possible. As to the consensus regularized autoencoder, an article “Transfer Learning with Multiple Sources via Consensus Regularized Autoencoders” published by F. Zhuang, X et al in “European Conference on Machine Learning” is incorporated herein by reference in its entirety.

In detail, the processor 11 may set the following target function by means of the consensus regularized autoencoder for the L K×N latent feature matrices 40 (K is an integer greater than or equal to 1 but smaller than or equal to M) shown in FIG. 4A or for the single K×N latent feature matrix 42 (K is an integer greater than or equal to 1 but smaller than or equal to P) shown in FIG. 4B:

min_{Θ,Θ′,{θ}_{ⱼ}_{}} [symbol] =∈(x_{S},\hat{x}_{S},x_{T},\hat{x}_{T})+γΩ(Θ,Θ′)+αl(z_{S},y_{S};{θⱼ})−βψ(z_{T};{θⱼ}) (16)

where:
∈(x_{S},\hat{x}_{S},x_{T},\hat{x}_{T})=Σⱼ₌₁^{r}Σᵢ₌₁ⁿ^{ⱼ}∥x_{S}_{ᵢ}−\hat{x}_{S}_{ᵢ}∥²+Σᵢ₌₁ⁿ∥x_{T}_{ᵢ}−\hat{x}_{T}_{ᵢ}∥², x_{S} is a feature set of the L latent feature matrix 40, \hat{x}_{S} is a feature set reconstructed through encoding and decoding x_{S}, x_{T} is a feature set in the target field (i.e., a feature set of a new commodity), \hat{x}_{T} is a feature set reconstructed through encoding and decoding x_{T}, r is the total number L of the data resources S₁˜S_{L}, and nⱼ is the total number of features in the feature set;
Ω(Θ,Θ′)=∥W∥²+∥b∥²+∥W′∥²+∥b′∥², Θ={W,b}, Θ′={W′,b′}, W and b are a weight matrix and a deviation vector of the encoder respectively, and W′ and b′ are a weight matrix and a deviation vector of the decoder respectively;
l(z_{S},y_{S};{θⱼ})=Σⱼ₌₁^{r}(−Σᵢ₌₁ⁿ^{ⱼ} log σ(y_{S}_{ᵢ}^{(j)}θⱼ^{T}z_{S}_{ᵢ}^{(j)})+λθⱼ^{T}θⱼ), z_{S} is a code of x_{S}, y_{S} is a labeled feature in the feature set, θⱼ is a parameter vector of the j^{th} classifier, and σ(⋅) is an S function (sigmoid function);

$$ψ ( {z}_{T} ; \{ {θ}_{j} \} ) = {\sum }_{i = 1}^{n} {‖ 2 \frac{{\sum }_{j = 1}^{r} σ ( {θ}_{j}^{T} {z}_{{T}_{i}} )}{r} - 1 ‖}^{2} ,$$

z_{T} is a code of x_{T}; and
γ, α, λ, and β are adjustable parameters ranging from 0˜1.

As compared to Formula (14), additional parameters evaluated in Formula (16) are: the reconstruction error Σᵢ₌₁ⁿ∥x_{T}_{ᵢ}−\hat{x}_{T}_{ᵢ}∥² resulting from encoding x_{T} by the autoencoder; and the consensus regulation ψ(z_{T};{θⱼ}) that is predicted by the source classifier in the target field. Given that the prediction result is determined by voting, the more consistent (or the more similar to each other) the voting results are, the greater the value of ψ(z_{T};{θⱼ}) will be. In Formula (16), ψ(z_{T};{θⱼ}) is subtracted from another item, so the more consistent (or the more similar to each other) the voting results are, the smaller the error value will be.

Likewise, the processor 11 may calculate closed-form solutions of Θ, Θ′ and {θⱼ} shown in Formula (16) according to the Gradient Descent algorithm or the like algorithm. In some embodiments, the processor 11 may then build a classifier f_{T} (equivalent to the prediction model 60 or 62) represented by θ_{T} according to Formula (15) and predict the market demand (e.g., sales volume of the commodity) of a target commodity according to the classifier f_{T}.

Further in some embodiments, after the closed-form solutions off θ, θ′ and {θⱼ} have been calculated, the processor 11 may encode x_{S} into z_{S} by means of the autoencoder again, and then train the labeled features according to various classifying algorithms (e.g., Support Vector Machine, Logistic Regression and so on) to derive a unified classifier f_{T} represented by θ_{T}. Afterwards, the unified classifier f_{T} is used to estimate the market demand of the target commodity.

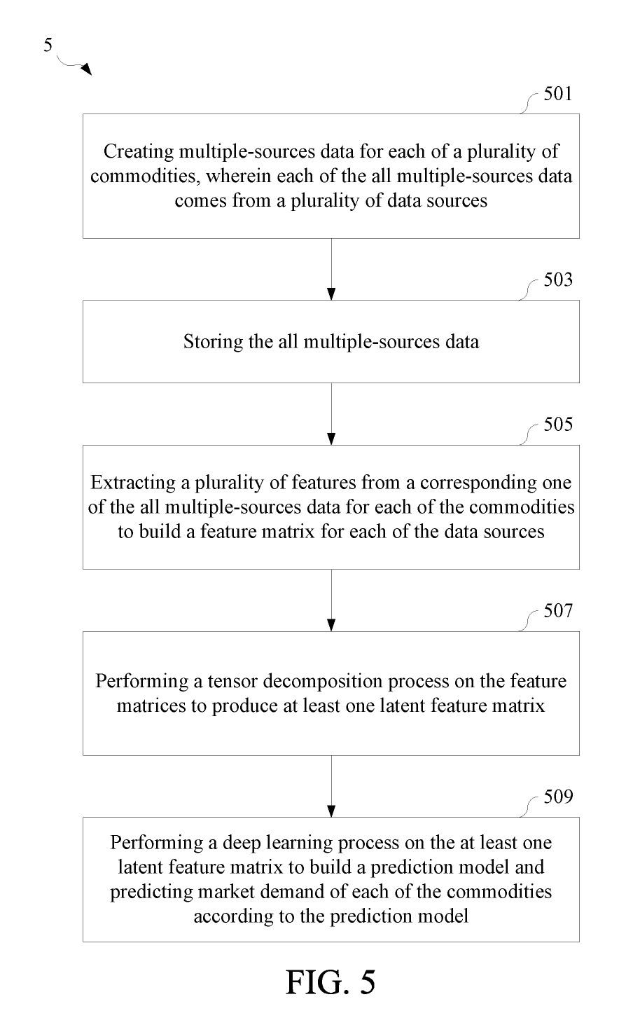

FIG. 5 illustrates a method for predicting market demand of commodities according to one or more embodiments of the present invention. However, the method illustrated in FIG. 5 is provided only an exemplary example but not to limit the present invention. Referring to FIG. 5, a method 5 for predicting market demand of commodities may comprise the following steps: creating multiple-sources data by a computer device for each of a plurality of commodities, wherein each of the all multiple-sources data comes from a plurality of data sources (501); storing the all multiple-sources data by the computer device (503); extracting a plurality of features from a corresponding one of the all multiple-sources data by the computer device for each of the commodities to build a feature matrix for each of the data sources (505); performing a tensor decomposition process by the computer device on the feature matrices to produce at least one latent feature matrix (507); and performing a deep learning process by the computer device on the at least one latent feature matrix to build a prediction model and predicting market demand of each of the commodities according to the prediction model (509). In FIG. 5, the sequence of Steps 501-509 is not intended to limit the present invention, but may be adjusted without departing from the spirit of the present invention.

In some embodiments, the method 5 may further comprise the following step: performing a synonym integration process and a text match-making process by the computer device on each of the commodities in the data sources to create the multiple-sources data associated with each of the commodities respectively.

In some embodiments, the features extracted by the computer device for each of the commodities may include at least one commodity feature, and the at least one commodity feature may be associated with at least one of commodity basic data, an affecting commodity factor, a commodity evaluation and a commodity sales record.

In some embodiments, the features extracted by the computer device for each of the commodities may include at least one text feature, and the computer device may extract the at least one text feature according to at least one of feature factor analysis, emotion analysis and semantic analysis.

In some embodiments, the features extracted by the computer device for each of the commodities may include at least one community feature, and the at least one community feature may be extracted by the computer device according to a community network discussion degree of each of the commodities.

In some embodiments, the method 5 may further comprise the following step: performing a commodity similarity comparing process and a miss value interpolation process by the computer device on the feature matrices before performing the tensor decomposition process on the feature matrices.

In some embodiments, the computer device may perform the tensor decomposition process on the feature matrices according to a predefined feature dimension value.

In some embodiments, the deep learning process may further comprise a transfer learning process. Additionally, the method 5 may further comprise the following step: predicting market demand of a new commodity by the computer device according to the prediction model.

In some embodiments, the method 5 may be applied to the computer device 1 and accomplish all the operations of the computer device 1. Because how the method 5 accomplishes these operations will be readily appreciated by those of ordinary skill in the art based on the description of the computer device 1, this will not be further described herein.

According to the above descriptions, in order to take more factors that may affect the market demand into consideration, the present invention builds a prediction model for predicting market demand according to multiple-sources data of commodities. Therefore, as compared with the conventional simple prediction model, the prediction model built according to the present invention can provide more accurate prediction of market demand of the modern commodities. Further in the process of building the prediction model, a tensor decomposition process is adopted to decompose the original feature matrix, so additional computations caused by taking more factors that may affect the market demand into consideration can be reduced and additional noises/interference data caused by taking more factors that may affect the market demand into consideration can be rejected. Thereby, an effective solution for predicting market demand of commodities has been provided in the present invention under conditions of the increased numbers of commodity categories, commodity sales channels and commodity data sources.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A computer device for predicting market demand of commodities, comprising:
a processor, being configured to create multiple-sources data for each of a plurality of commodities, wherein each of the all multiple-sources data comes from a plurality of data sources; and
a storage, being configured to store the all multiple-sources data;
wherein the processor is further configured to:
extract a plurality of features from a corresponding one of the all multiple-sources data for each of the commodities to build a feature matrix for each of the data sources;
perform a tensor decomposition process on the feature matrices to produce at least one latent feature matrix; and
perform a deep learning process on the at least one latent feature matrix to build a prediction model and predict market demand of each of the commodities according to the prediction model.

2. The computer device according to claim 1, wherein the processor further performs a synonym integration process and a text match-making process on each of the commodities in the data sources to create the multiple-sources data associated with each of the commodities respectively.

3. The computer device according to claim 1, wherein the features extracted by the processor for each of the commodities include at least one commodity feature, and the at least one commodity feature is associated with at least one of commodity basic data, an affecting commodity factor, a commodity evaluation and a commodity sales record.

4. The computer device according to claim 1, wherein the features extracted by the processor for each of the commodities include at least one text feature, and the processor extracts the at least one text feature according to at least one of feature factor analysis, emotion analysis and semantic analysis.

5. The computer device according to claim 1, wherein the features extracted by the processor for each of the commodities include at least one community feature, and the at least one community feature is extracted by the processor according to a community network discussion degree of each of the commodities.

6. The computer device according to claim 1, wherein the processor further performs a commodity similarity comparing process and a miss value interpolation process on the feature matrices before performing the tensor decomposition process on the feature matrices.

7. The computer device according to claim 1, wherein the processor performs the tensor decomposition process on the feature matrices according to a predefined feature dimension value.

8. The computer device according to claim 1, wherein the deep learning process further comprises a transfer learning process, and the processor further predicts market demand of a new commodity according to the prediction model.

9. A method for predicting market demand of commodities, comprising:
creating multiple-sources data by a computer device for each of a plurality of commodities, wherein each of the all multiple-sources data comes from a plurality of data sources;
storing the all multiple-sources data by the computer device;
extracting a plurality of features from a corresponding one of the all multiple-sources data by the computer device for each of the commodities to build a feature matrix for each of the data sources;
performing a tensor decomposition process by the computer device on the feature matrices to produce at least one latent feature matrix; and
performing a deep learning process by the computer device on the at least one latent feature matrix to build a prediction model and predicting market demand of each of the commodities according to the prediction model.

10. The method according to claim 9, further comprising:
performing a synonym integration process and a text match-making process by the computer device on each of the commodities in the data sources to create the multiple-sources data associated with each of the commodities respectively.

11. The method according to claim 9, wherein the features extracted by the computer device for each of the commodities include at least one commodity feature, and the at least one commodity feature is associated with at least one of commodity basic data, an affecting commodity factor, a commodity evaluation and a commodity sales record.

12. The method according to claim 9, wherein the features extracted by the computer device for each of the commodities include at least one text feature, and the computer device extracts the at least one text feature according to at least one of feature factor analysis, emotion analysis and semantic analysis.

13. The method according to claim 9, wherein the features extracted by the computer device for each of the commodities include at least one community feature, and the at least one community feature is extracted by the computer device according to a community network discussion degree of each of the commodities.

14. The method according to claim 9, further comprising:
performing a commodity similarity comparing process and a miss value interpolation process by the computer device on the feature matrices before performing the tensor decomposition process on the feature matrices.

15. The method according to claim 9, wherein the computer device performs the tensor decomposition process on the feature matrices according to a predefined feature dimension value.

16. The method according to claim 9, wherein the deep learning process further comprises a transfer learning process, and the method further comprising:
predicting market demand of a new commodity by the computer device according to the prediction model.
